(19) United States
(12) Patent Application Publication
(10) Pub. No.: US 2010/0272068 A1
(43) Pub. Date: Oct. 28, 2010

(54) METHOD FOR SUPPORTING MULTIPLE INTERFACES IN PROXY MOBILE IPV6

(75) Inventors: Hyun Seo Park, Daejeon (KR); Gyung Chul Shin, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/808,882

(22) PCT Filed: Oct. 10, 2008
(86) PCT No.: PCT/KR08/06004

§ 371 Date: Jun. 17, 2010

(30) Foreign Application Priority Data
Dec. 17, 2007 (KR) 10-2007-0132821

(51) Int. Cl. H04W 36/00

(52) U.S. Cl. 370/331

(57) ABSTRACT

The present invention is related to a method for managing mobility of a mobile node and a system using the method employing Proxy Mobile IP technology. A method for managing mobility of a mobile node and a system using the method according to the present invention minimizes overhead imposed on LMA (Local Mobility Anchor) when a mobile node carries out handover or multiple connections and complements a drawback observed when LMA of Proxy Mobile IP carries out multiple connections. To achieve the above advantages, in a method for managing mobility of a mobile node and a system using the method according to the present invention, LMA and MAG utilizes connection type information of a mobile node.

### TECHNICAL FIELD

The present invention is related to a method for supporting multiple interfaces of a mobile node and a system utilizing Proxy Mobile IP where LMA (Local Mobility Anchor) provides transparent session continuity for a mobile node and minimizes overhead caused by a movement of the mobile node.

The present invention was supported by the IT R&D program of Ministry of Information and Communication (MIC) and Institute for Information Technology Advancement (IITA) [Project No.: 2006-S-003-02, Project Title: Development of Next-Generation Mobile Communication Service Platform]

### BACKGROUND ART

A mobile node carries out communication using a single IP (Internet Protocol) address consisting of a network identifier and a host identifier.

A network identifier is used to identify a network to which a mobile node is connected and a host identifier is used to identify a mobile node in the corresponding network.

A mobile node generates a socket address by using an IP address and a port number of a transport layer and sets up connection to other hosts by using the generated socket address. If a mobile node establishes connection to a different host, the same IP should be shared by the mobile node and the different host while connection is maintained.

Since a network identifier should be changed as a mobile node moves from one network to another, IP address of the mobile node should also be changed. Since change of IP address causes change of socket address, a previous connection established for the mobile node is released and the mobile node should connect to a new network.

As described above, re-connecting to a network every time a mobile node moves into a new network impairs session continuity due to unnecessary overhead. Proxy Mobile IP technology has been proposed to solve the above re-connecting problem.

In the Proxy Mobile IP technology, Local Mobility Anchor (LMA) that manages a network receives a Proxy Binding Update message from Mobile Access Gateway (MAG) that can communicate with a mobile node. Depending on a Proxy Binding Update message transferred by MAG, LMA maintains a binding of a mobile node to MAG.

When a mobile node carries out handover between multiple interfaces from a previous MAG to a new MAG, if the new MAG notifies LMA of connection of the mobile node before the first MAG notifies LMA of disconnection, handover of the mobile can result in failure.

Moreover, it is difficult for LMA that employs Proxy Mobile IP technology to support multiple connections for a mobile node using multiple interfaces simultaneously.

When a mobile node connects to a new MAG, LMA that employs Proxy Mobile IP technology disconnects the mobile node from a previous MAG to which the mobile node has been connected. This implies that LMA employing Proxy Mobile IP technology is not suitable for multiple connections and handover.

### DISCLOSURE OF INVENTION

### Technical Problem

One aspect of the present invention is to provide a method for managing mobility of a mobile node that guarantees mobility of a mobile node by preserving binding information about a mobile node and a system for managing mobility of a mobile node.

Another aspect of the present invention is to provide a method for managing mobility of a mobile node that enables a mobile node to maintain the same network prefix even when a mobile node carries out handover or multiple connections under Proxy Mobile IP environment and a system for managing mobility of a mobile node.

A further aspect of the present invention is to provide a method for managing mobility of a mobile node that minimizes overhead of LMA when a mobile node carries out handover, normal connection, or multiple connections and a system for managing mobility of a mobile node.

### TECHNICAL SOLUTION

In one embodiment of the present invention, the above advantages are achieved by receiving from one of multiple gateways a Proxy Binding Update message carrying connection type information specifying handover, normal connection, or multiple connections; determining through the Proxy Binding Update message a first gateway that requires connection to a mobile node and a second gateway that does not require connection to a mobile node; and setting up a connection path to the mobile node with respect to the first gateway and processing connection removal for the second gateway.

In another embodiment of the present invention, the above advantages are achieved by a message transceiver that receives from one of multiple gateways a Proxy Binding Update message carrying connection type information specifying handover, normal connection, or multiple connections; an extraction unit that determines through the Proxy Binding Update message a first gateway that requires connection to a mobile node and a second gateway that does not require connection to a mobile node and extracts connection type of the mobile node; and a connection path manager that sets up a connection path to the mobile node with respect to the first gateway and processing connection removal for the second gateway.

### ADVANTAGEOUS EFFECTS

The present invention provides session continuity for a mobile node without disconnection of the mobile node when the mobile node carries out handover and multiple connections.

A method for managing mobility of a mobile node and a system using the method hardly generates overhead when LMA re-assigns IP address to a mobile node, manages mobility of a mobile node according to change of IP address, or connects a mobile node to a different MAG according to change of IP address.

The present invention enables a mobile node to maintain the same network prefix while the mobile node is moving.

### BRIEF DESCRIPTION OF THE DRAWINGS

The accompanying drawings, which are included to provide a further understanding of the invention, illustrate the preferred embodiments of the invention, and together with the description, serve to explain the principles of the present invention. In the drawings:

FIG. 1 illustrates an internal block diagram of a mobile node according to one embodiment of the present invention;

FIG. 2 illustrates an internal block diagram of LMA (Local Mobility Anchor) according to one embodiment of the present invention;

FIG. 3 illustrates an exemplary block diagram of a system to which a method for managing mobility according to the present invention is applied;

FIG. 4 illustrates a message flow between a mobile node, MAG, and LMA when a binding message represents normal connection type;

FIG. 5 illustrates a case where a mobile node carries out handover connection according to one embodiment of the present invention;

FIG. 6 illustrates a message flow between a mobile node, MAG, and LMA when connection type of a mobile node is handover;

FIG. 7 illustrates a case where a mobile node carries out multiple interface connection according to another embodiment of the present invention;

FIG. 8 illustrates a sequence diagram for multiple interface connection type of FIG. 7; and

FIG. 9 illustrates a flow diagram of one embodiment of a method for managing mobility according to the present invention.

### BEST MODE FOR CARRYING OUT THE INVENTION

Hereinafter, preferred embodiments of the present invention will be described in detail with reference to appended drawings.

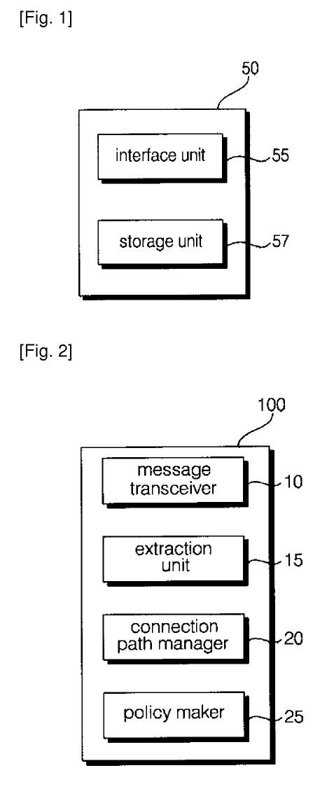

FIG. 1 illustrates an internal block diagram of a mobile node 50 according to one embodiment of the present invention.

A mobile node 50 comprises an interface unit 55 comprising interfaces transmitting and receiving packets and a storage unit 57 equipped with path information of packets transmitted and received through the interface unit 55.

The interface unit 55 can be realized in the form of a wireless LAN card, a wireless communication module supporting mobile communication, or Bluetooth.

The storage unit 57 can be equipped with information about MAG (Mobile Access Gateway) to which a mobile node 50 has made connection before.

FIG. 2 illustrates an internal block diagram of LMA (Local Mobility Anchor) according to one embodiment of the present invention.

With reference to FIG. 2, LMA (Local Mobility Anchor) 100 that manages mobility comprises a message transceiver 10 transmitting and receiving a mobility signaling message, an extractor 15 extracting connection type from a binding message and a connection path manager 20 managing connection paths of a mobile node. LMA 100 can further comprise a policy maker 25 that determines a packet scheduling policy for a mobile node 50 when the mobile node 50 carries out multiple connections.

A connection path manager 20 generates, changes, and removes a connection path for a mobile node and MAG.

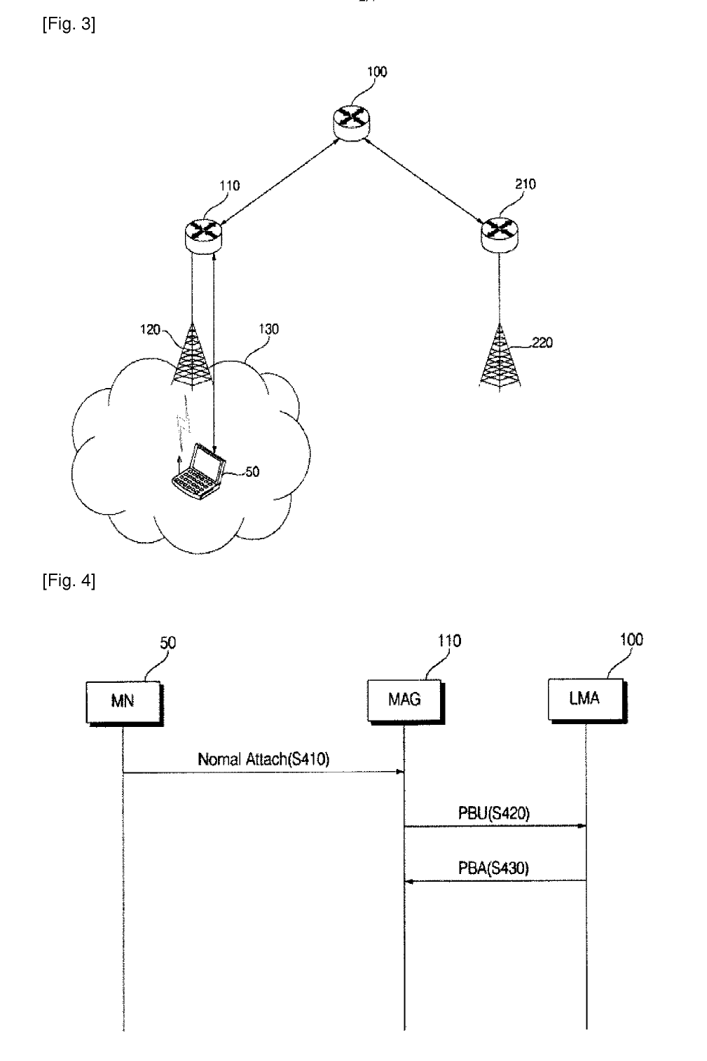

FIG. 3 illustrates an exemplary block diagram of a system to which a method for managing mobility according to the present invention is applied.

The illustrated system represents a system employing Proxy Mobile IP technology.

As shown in the figure, a system for managing mobility comprises LMA (Local Mobility Anchor) 100 that manages mobility of a mobile node, MAG (Mobile Access Gateway) 110, 210 that responds to a connection request of a mobile node, a station 120, 220, and a mobile node 50.

A mobile node 50 comprises a wireless transceiver, an antenna, and a control unit and can carry out wireless connection to a station 120, 220 through a wireless transceiver.

A mobile node 50 can be a mobile communication terminal, PDA, or a notebook computer. In addition to the above, any kind of a device capable of wireless communication through a station 120, 220 can correspond to a mobile node 50.

A mobile node 50 connects to MAG 110, 210 through wireless connection to a station 120, 220 in Proxy Mobile IP network 130, 230 and receives network access service. A mobile node 50 receives a network prefix information from MAG 110, 210 and sets up IP address of itself using that prefix. MAG (Mobile Access Gateway) 110, 210 is a device that supports mobility of a mobile node 50 on behalf of a mobile node 50, detecting movement of a mobile node 50 and transfers a Proxy Binding Update message to LMA 100. LMA 100 processes a Proxy Binding Update message and if a mobile node is registered with a network successfully, informs MAG 110, 210 of network prefix information of a mobile node 50. MAG 110, 210 transfers the network prefix information to a mobile node 50.

A Proxy Binding Update message carries information about through which MAG (either 110 or 210) a mobile node 50 has established a connection path to LMA 100, information of MAG 110, 210 connected to a mobile node 50, and information about connection type.

There are three connection types: normal connection type where a mobile node 50 makes initial connection to MAG (either 110 or 210), handover connection type where a mobile node 50 moves to a different MAG, and multiple interface connection type where a mobile node 50 makes connection to more than two MAGs simultaneously.

Based on connection type, LMA 100 can determine MAG (one of 110 and 210) to be connected to a mobile node 50 and MAG (the other one of 110 and 210) for which connection to a mobile node 50 is to be removed.

For a binding message, PBU (Proxy Binding Update) message, PBA (Proxy Binding Acknowledgement) message, PBRI (Proxy Binding Revocation Indication) message, and PBRA (Proxy Binding Revocation Acknowledgement) message are used. Detailed description of a binding message is given later.

A station 120, 220 connects a wired network with a wireless network. In wireless LAN, an access point plays the role of a station.

FIG. 4 illustrates a message flow between a mobile node 50, MAG 110, 210, and LMA 100 when a mobile node does normal connection.

First, if a mobile node 50 carries out normal connection S410 to MAG 110, MAG 110 transfers PBU (Proxy Binding Update) message to LMA 100, S420. PBU message can comprise ID of a mobile node 50, MAC address of a mobile node 50, MAG information that a mobile node 50 has accessed before, and information about connection mode.

LMA 100 that has received PBU message sets up a normal connection path. LMA 100 establishes a tunnel between LMA 100 and MAG 110 by using address information of MAG 110 and a mobile node 50 carries out data communication through the tunnel.

LMA 100 determines connection type of a mobile node 50 by using connection type information. Also, LMA 100 can know connection type of a mobile node 50 by determining existence of ID of a mobile node 50 from previous binding information.

PBU message can include information about previous MAG to which a mobile node 50 connected before. If there is no information about previous MAG, it is assumed that a mobile node 50 made an initial connection, connection type being determined as normal mode.

LMA 100, in response to PBU message, sends PBA (Proxy Binding Acknowledgement) message to MAG 110, S430.

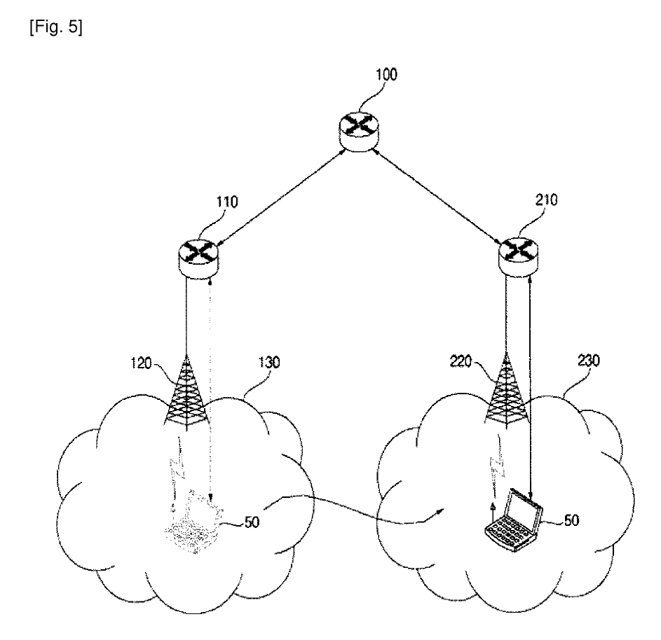

FIG. 5 illustrates a case where a mobile node carries out handover connection according to one embodiment of the present invention.

When a mobile node 50 is connected to MAG 110, 210 according to handover type, the mobile node 50 is directly associated with two MAGs 110, 210.

If a mobile node 50 carries out handover from MAG 110 to MAG 210, connection to a previous MAG 110 should be removed whereas connection to a new MAG 210 should be established. A conventional handover procedure consists of notifying LMA 100 of connection removal by MAG 110 and a new connection by MAG 210. If a message notifying of a new connection from MAG 210 arrives at LMA 100 earlier than a message notifying connection removal from MAG 110, connection between a mobile node 50 and LMA 100 became invalid. However, since MAG 110, 210 notifies LMA 100 of connection type of a mobile node 50 in the present invention, connection to a mobile node 50 is not invalidated during handover of the mobile node 50.

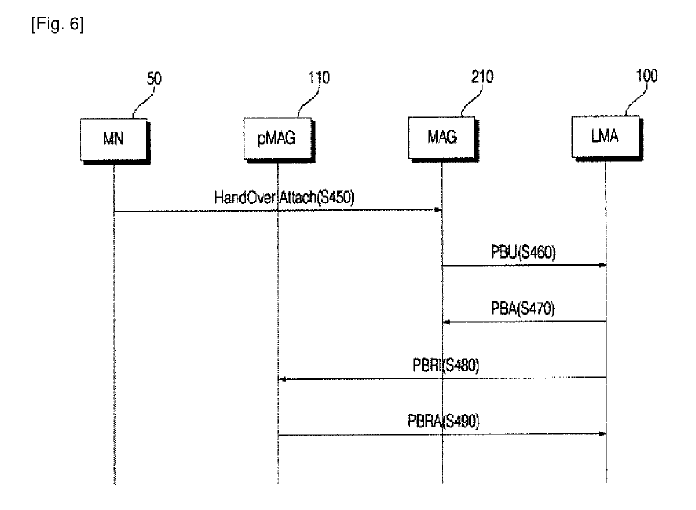

FIG. 6 illustrates a message flow between a mobile node, MAG, and LMA when connection type of a mobile node is handover.

At the time of a mobile node 50 carrying out handover connection to MAG 210, S450, a mobile node 50 requests handover from MAG 210. If MAG 210 accepts the request, the mobile node 50 transfers a handover complete message to MAG 210. At this time, a mobile node 50 provides “Network Address Information” for MAG 210; “Network Address Information” can include information about MAG 110 to which a mobile node 50 has previously connected.

MAG 210 notifies LMA 100 through PBU (Proxy Binding Update) message of the fact that a mobile node 50 is connected to MAG 210 itself S460.

PBU message can comprise ID of a mobile node 50, MAC address of a mobile node 50, network prefix assigned to a mobile node 50, IP address of a mobile node 50, information about a previous MAG 110 obtained from “Network Address Information” and connection type of a mobile node 50.

LMA 100 that received PBU message sets up a handover connection path. LMA 100 establishes a tunnel between LMA 100 and MAG 210 by using address information of MAG 210 and enables a mobile node 50 to carry out data communication through the tunnel.

In response to PBU message, LMA 100 sends PBA (Proxy Binding Acknowledgement) message to MAG 210 (S470).

By using information about a previous MAG (pMAG) 110 included in PBU message, LMA 100 can transfer PBRI (Proxy Binding Revocation Indication) to the previous MAG 110 to notify that a mobile node 50 has done handover to a different MAG 210 (S480).

In response to PBRI message, MAG 110 can transfer PBRA (Proxy Binding Revocation Acknowledgement) message to LMA 100 (S490).

LMA 100 removes a tunnel established for a previous MAG 110. By doing this, only a connection path that goes through MAG 210 remains between LMA 100 and a mobile node 50.

When connection type is handoff type, a mobile node 50 maintains the same network prefix and IP address, only MAG information changed. Since LMA 100 receives update message (PBU message) about binding information only from MAG 210, there is no chance that incorrect binding information is stored due to PBU message of a previous MAG 110.

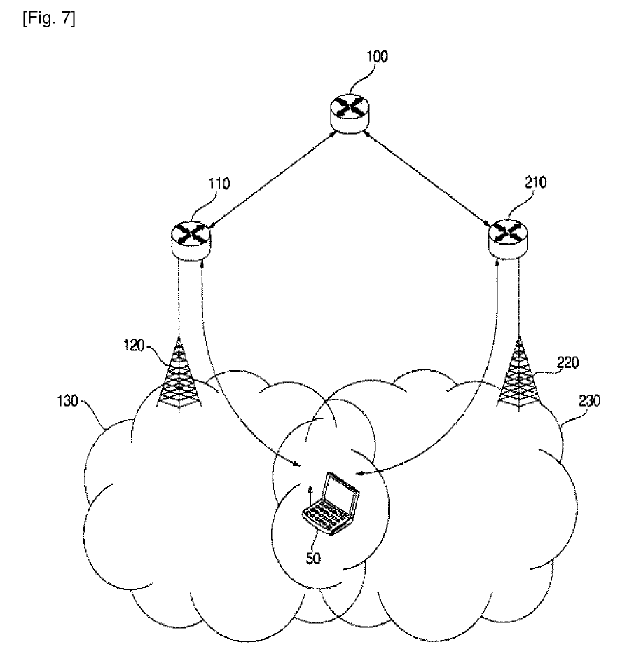

FIG. 7 illustrates a case where a mobile node carries out multiple interface connection according to another embodiment of the present invention.

In general, multiple interface connection is not well supported in Proxy Mobile IP environment. In the Proxy Mobile IP environment, a mobile node 50 does not maintain a connected state for more than two MAGs 110, 210 at the same time. In the present invention, while a mobile node 50 is kept connected to MAG (for example, reference number 110), multiple connection is handled in such a way that a connection path of a new MAG (for example, reference number 210) is added to the mobile node 50. FIG. 7 illustrates that a mobile node 50 carries out connecting to a new MAG 210 through a network while maintaining connection to a previous MAG 110.

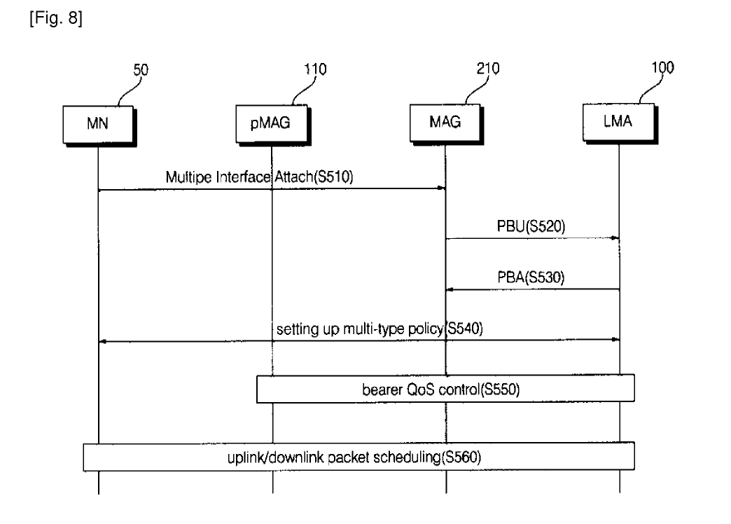

FIG. 8 illustrates a sequence diagram for multiple interface connection type of FIG. 7.

First, a mobile node 50 carries out multiple interface connection to MAG 220, S510. A mobile node 50 notifies LMA 100 through a layer 2 message such as a network connection message that it carried out connecting to MAG 210 through a network.

At this time, a layer2 message can comprise connection type and previous MAG information as information for PBU message. In the present embodiment, connection type is multiple connections and previous MAG information is MAG 110.

MAG 210 that received a layer2 message reports to LMA 100 through PBU (Proxy Binding Update) message that a mobile node 50 is connected to MAG 210 itself, S520. PBU message can comprise ID of a mobile node 50, MAC address of a mobile node 50, network prefix assigned to a mobile node 50, IP address of a mobile node 50, information about a previous MAG 110 obtained from a layer2 message, and connection mode.

LMA 100, through connection type information included in PBU message, determines that connection type of a mobile node 50 is multiple connections. LMA 100 that received PBU message sets up a multiple connection path between a mobile node 50 and MAG 110, 210. LMA 100 establishes a tunnel between LMA 100 and MAG 210 by using address information of MAG 210 and carries out data transfer between LMA 100 and a mobile node 50 through the tunnel. Accordingly, a first connection path that passes MAG 110 and a second connection path that passes MAG 210 exist together between LMA 100 and a mobile node 50.

In response to PBU message, LMA 100 can transfer PBA (Proxy Binding Acknowledgement) message to MAG 210, S530.

In multiple connection type, a mobile node 50 can maintain the same network prefix and IP address. This is possible because LMA 100 receives update message (PBU message) about binding information only through MAG 210; there is no chance that incorrect binding information is generated due to PBU message of a previous MAG 110.

LMA 100 can determine a packet scheduling policy according to multiple connections by negotiating with a mobile node 50, S540. LMA 100 carries out QoS (Quality of Service) control for MAG 110, MAG 210, and bearer according to the packet scheduling policy S550. A bearer supports QoS by using a manageable path specified by an operation, namely LMA 100.

LMA 100 can either transfer downlink packets to a mobile node 50 according to a determined packet scheduling policy or receive uplink packets from a mobile node 50, S560.

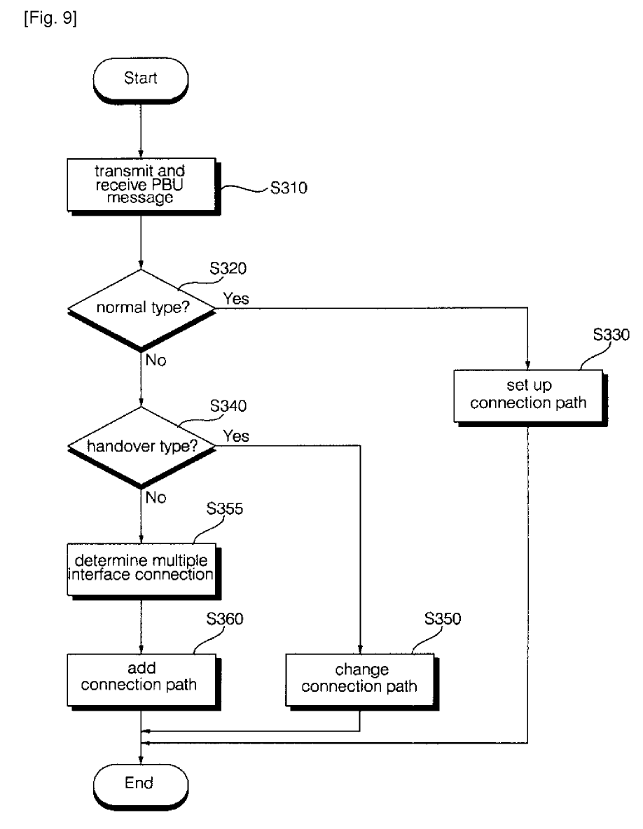

FIG. 9 illustrates a flow diagram of one embodiment of a method for managing mobility according to the present invention.

When a mobile node 50 connects to a Proxy Mobile IP network, MAG 110, 210 transfers PBU message to LMA 100 notifying that a mobile node 50 has connected to MAG 110, 210 itself S310.

PBU message comprises connection type of a mobile node and information of a previous MAG. A mobile node 50 transfers a layer2 message notifying that the mobile node itself has connected to a network. A layer2 message can comprise connection type and information of a previous MAG.

Connection type can be determined by LMA 100 through connection type information included in a layer2 message or connection type information included in PBU message.

LMA 100 that received PBU message updates binding information based on information included PBU message and establishes a connection path according to connection type.

First, whether it is normal connection type is determined. The above determination is based on existence of binding information about a mobile node 50, existence of information about a previous MAG, or connection type. If no binding information or no information about a previous MAG exists, or if connection type is normal connection type, it is determined as normal connection type. In the present embodiment, it is determined by connection type S320.

In case of normal connection type, a connection path is set up as shown in FIGS. 3 and 4, S330. If required, LMA 100 communicates with MAG 110 by using messages.

LMA 100 determines whether it is handover type S340. If it corresponds to handover type, LMA 100 changes a connection path as shown in FIGS. 5 and 6, S350. If required LMA 100 communicates with MAG 110, 210 by using messages.

LMA 100 determines as multiple interface connection type if it is neither normal connection type nor handover type, S355. LMA 100 adds a connection path as shown in FIGS. 7 and 8, S360. If required, LMA 100 communicates with MAG 210 by using messages.

The present invention described above can be implemented in the form of computer-readable codes in a computer-readable recording medium. A computer-readable recording medium implies all kinds of recording devices where data that can be read by a computer system are stored. Examples of a computer-readable recording medium are ROM, RAM, CD-ROM, magnetic tape, floppy disk, and optical data storage device. A device implemented in the form of carrier waves (for example, transfer through the Internet) is also counted as another example. Moreover, a computer-readable recording medium can be distributed across computer systems connected to each other through a network and computer-readable codes can be stored and executed in a distributed computing environment. Functional programs, codes, and code segments can be easily inferred by programmers of the technical field to which the present invention belongs.

So far, preferred embodiments of the present invention have been described with reference to appended drawings. The present invention is not limited by the particular embodiments above and it is certain that various modifications of the present invention can be carried out within the scope of the claims of the present invention by those skilled in the art to which the present invention belong. Those modifications should not be understood individually from technical principles or prospect of the present invention.

### INDUSTRIAL APPLICABILITY

The present invention can be applied to a mobile network under Proxy Mobile IP environment and by enabling a mobile node to maintain the same network prefix all the time, provide a communication environment without session discontinuity for a mobile terminal.

1. A method for managing mobility of a mobile node, comprising:
receiving from one of multiple gateways a binding message carrying connection type information specifying handover, normal connection, or multiple connections;
determining through the binding message a first gateway that requires connection to a mobile node and a second gateway that does not require connection to a mobile node; and
setting up a connection path to the mobile node with respect to the first gateway and processing connection removal for the second gateway.

2. The method of claim 1, wherein when the connection type information is the handover, the processing notifies a gateway to which the mobile node has previously connected of connection removal.

3. The method of claim 2, wherein the first gateway includes in the binding message information about the second gateway to which the mobile node has previously connected when the mobile node requests the handover.

4. The method of claim 1, wherein the processing sets up connection paths to more than two gateways required for the multiple connection when the connection type information is the multiple connection.

5. A system for managing mobility of a mobile node, comprising:
a message transceiver that receives from one of multiple gateways a binding message carrying connection type information specifying handover, normal connection, or multiple connections;
an extraction unit that determines through the binding message a first gateway that requires connection to a mobile node and a second gateway that does not require connection to a mobile node and extracts connection type of the mobile node; and
a connection path manager that sets up a connection path to the mobile node with respect to the first gateway and processing connection removal for the second gateway.

6. The system of claim 5, wherein when the connection type information extracted from the extraction unit is the handover, the connection path manager notifies a gateway to which the mobile node has previously connected of connection removal.

7. The system of claim 5, wherein the first gateway includes in the binding message information about the second gateway to which the mobile node has previously connected when the mobile node requests the handover.

8. The system of claim 5, wherein the connection path manager sets up connection paths to more than two gateways required for the multiple connection when the connection type information is the multiple connection.

9. The system of claim 8, further comprising a policy maker that carries out bearer QoS control of more than two gateways connected to the mobile node.

10. The system of claim 5, wherein the first gateway includes in the binding message information about the second gateway to which the mobile node has previously connected when the mobile node requests the handover.
